(19) United States
(12) Patent Application Publication
(10) Pub. No.: US 2008/0176977 A1
(43) Pub. Date: Jul. 24, 2008

(54) Burst resistant bubbles

(76) Inventor: John Pastorello, Fullerton, CA (US)

Correspondence Address: AVERILL & VARN, 8244 PAINTER AVE., WHITTIER, CA, 90602, US

(21) Appl. No.: 11/657,298

(22) Filed: Jan. 23, 2007

(51) Int. Cl. C08K 5/05; C08L 31/00; C08L 39/00; C08L 49/00; C08L 29/04; C08K 5/42; C08K 5/32; C08K 5/3445

(52) U.S. Cl. 524/105; 524/556; 524/555; 524/548; 524/550; 524/557; 524/157; 524/259; 524/379

(57) ABSTRACT

An aqueous bubble solution includes at least one water soluble polymer, at least one surfactant, and at least one fast drying solvent or solvent blend. The water soluble polymer forms a strong and resilient bubble wall. The surfactant(s) lowers the surface tension of the solution to create a bubble blowing film. The fast evaporating solvent or solvent blend acts to harden the bubble wall by dehydration and rapid evaporation. Bubbles blown from the solution will air dry within seconds and exhibit extraordinary strength. The bubbles do not evaporate and resist breakage upon collision with a dry surface. The bubbles remain translucent and fully preserved for hours or even days while resting on a surface.

### BACKGROUND OF THE INVENTION

The present invention relates to bubbles blown for recreation, entertainment, or amusement and in particular to the components of an aqueous solution which produces bubbles of exceptional strength and life span.

Soap or soap like solutions can form bubbles when entrained with air or like gases. Typically these solutions yield fragile bubbles which are short lived. Bubble rupture may occur by (1) contact or collision with a dry surface, (2) fluid evaporation, (3) fluid drainage, (4) gas leakage through the bubble wall and/or (5) by applying sufficient physical force to rupture the bubble wall.

In order to fortify a bubble, bubble formulators have used ingredients such as Glycerin to retard evaporation and Polymers to add strength to the bubble wall. It is also noted that certain surfactants in various combinations and concentrations may improve the quantity and quality of the resultant bubbles.

Classic bubble formulations are given in U.S. Pat. No. 4,284,534 for “Aqueous Bubble Blowing Composition” and U.S. Pat. No. 4,511,497 for “Bubble Composition Using Multipurpose Surfactant Base”, both issued to Ehrlich. Ehrlich makes use of one or more polymers and one or more surfactants, plus different additives to give a multitude of bubble effects. Ehrlich's example formulations almost always contain glycerin. Glycerin is classified as a humectant, a substance which absorbs and retains moisture. Unfortunately, the polymers cellulose ether, polyethylene oxide, polyvinylpyrrolidone, and the like, relied upon by Ehrlich do not produce good results when combined with a fast drying/evaporating solvent which are included in an improved bubble solution described below, and the use of humectants is unnecessary.

The Ehrlich examples, and the many patents that followed, are all based on “wet bubble formulations”. Wet meaning the bubble is primarily a water bond liquid and/or a bubble solution fortified with humectants or other oily liquids. U.S. Pat. No. 6,593,375 for “Toy Bubblemaking Solution” issued to Ammon Jr., describes bubbles having good integrity which are relatively long lasting. The improved bubbles tend to opacify as they change phase from a liquid to solid and the '375 patent observes that some of these solid opaque bubbles may not immediately burst upon contact with a dry surface. The formulations of the '375 patent use one or more cationic components to complex with anionic components in the solution. The '375 patent also observed bubble improvement when using block copolymers of propylene oxide and ethylene oxide, namely Pluronic® block copolymer and/or Tetronic® block copolymer made by BASF in a bubble producing solution. The present invention does not rely on cationic materials to interact with the surfactant(s) and also finds the Pluronic® block copolymer and/or Tetronic® block copolymer material inadequate.

Thus, very little progress has been made to improve the quality of bubble blowing solutions since the Ehrlich patents cited herein. One important quality is how long a bubble can sustain integrity. If a blown bubble floats in air for a few seconds before evaporating or bursts on contact with a surface, the entertainment is short-lived. If on the other hand, the floating bubble does not evaporate and can withstand an impact and/or come to rest on a surface without demise, the wonderment persists. Bubbles which can be captured fully intact on one's fingertip, hand, clothing, object, or article would offer a new and unique interaction.

### BRIEF SUMMARY OF THE INVENTION

The present invention addresses the above and other needs by providing an aqueous bubble solution including at least one water soluble polymer, at least one surfactant, and at least one fast drying solvent or solvent blend. The water soluble polymer forms a strong and resilient bubble wall. The surfactant(s) lowers the surface tension of the solution to create a bubble blowing film. The fast evaporating solvent or solvent blend acts to harden the bubble wall by dehydration and rapid evaporation. Bubbles blown from the solution will air dry within seconds and exhibit extraordinary strength. The bubbles do not evaporate and resist breakage upon collision with a dry surface. The bubbles remain translucent and fully preserved for hours or even days while resting on a surface.

The bubble solution contains from approximately 0.5 percent by weight to approximately 30 percent by weight of at least one water soluble polymer, and preferably from approximately one percent by weight to approximately 15 percent by weight of at least one water soluble Polymer and more preferably approximately three percent by weight to approximately fifteen percent by weight of a high molecular weight partially hydrolyzed Polyvinyl Alcohol. The bubble solution further includes approximately 0.5 percent by weight to approximately 30 percent by weight of surface active agents (or surfactant) generally used to make a bubble solution, and preferably approximately two percent by weight to approximately ten percent by weight of surfactant. Additionally, the bubble solution includes approximately 0.25 percent by weight to approximately 30 percent by weight of a fast evaporating solvent or solvent blend, and preferably approximately two percent by weight to approximately fifteen percent by weight of ethanol.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention is a novel bubble making solution containing approximately 0.5 percent by weight to approximately 30 percent by weight of at least one water soluble polymer, approximately 0.5 percent by weight to approximately 30 percent by weight of a surfactant, and approximately 0.25 percent by weight to approximately 30 percent by weight of a solvent. The function of the dissolved polymer is to form a strong and resilient bubble wall. The surfactant lowers the surface tension of the solution to create a bubble blowing film. A fast evaporating solvent or solvent blend hardens the bubble wall by dehydration and rapid evaporation. The bubble solution according to the present invention may be used with any bubble generating method or device.

### The Water Soluble Polymer.

Not all water soluble polymers are optimal and/or ideal for use in the bubble making solution. The polymers disclosed in the prior art do not generally achieve satisfactory results for bubble making. The ideal polymer must be able to withstand the rapid drying/evaporative action of the solvent or solvent blend and still maintain inflation and clarity.

By experimentation, it was determined that the cellulose, xanthan, starch, gelatin, carrageenan, guar, polyethylene oxide, polyvinyl pyrrolidone and polyamide materials were poor to non-functional water soluble polymers for bubble making solutions. Some of the acrylic, acrylamide polymers and block polymers of propylene and ethylene oxide were fair performers, but the best candidates were the polyvinyl alcohols and polyvinyl acetates. However, bubbles made from the polyvinyl acetate polymers were often milky in appearance and resembled white balloons rather than clear spheres. Therefore, the polyvinyl alcohols are the preferred water soluble polymer for the bubble solution. It is also preferred to use polyvinyl alcohols of high molecular weight to achieve formulation efficiency and cost effectiveness. This is because the lower molecular weight varieties require greater amounts of material in solution to equal the performance of the high molecular weight materials.

In addition, there are two types of polyvinyl alcohol available, fully hydrolyzed polyvinyl alcohol and partially hydrolyzed polyvinyl alcohol. The fully hydrolyzed polyvinyl alcohol is only partially soluble in cold water and the water must be carefully heated to fully dissolve the polymer. The partially hydrolyzed polyvinyl alcohol readily dissolves in cold water and is preferred due to ease of preparation. Example of suitable polymers are Celvol® 523S Polyvinyl Alcohol, Celvol® 540S Polyvinyl Alcohol, and Celvol® 203S Polyvinyl Alcohol made by Celanese Corporation in Dallas, Tex.

### The Surfactant.

There are numerous detergent grade surfactants which may work well in the bubble solution. It is preferred to choose from the high foaming materials. The high foaming surfactants usually have a nominal C-8 to C-18 carbon chain molecular backbone and the surfactants falling in the range of C-12 to C-14 produce the best bubble making solutions and are preferred.

The surfactants typically used to produce good bubble solutions are the lauryl sulfates/sulfonates, coco sulfates/sulfonates, dodecylbenzene sulfates/sulfonates, lauryl and coco amine oxides, lauryl and coco betaines, lauryl and coco sulfobetaines, lauryl and coco succinates, lauryl and coco sulfosuccinates, lauryl and coco imidazolines, lauryl and coco gylcinates, lauryl and coco propinates, lauryl and coco amides, lauryl and coco sarcosinates, lauryl and coco taurinates, lauryl and coco carboxylates, ethoxylated alcohols, ethoxylated amines, ethoxylated amides, ethoxylated phenols, alkyl olefins, [neutralized] fatty acid soaps, protein-based surfactants and carbohydrate-based surfactants. Any of the above surfactants may be used independently or in combination, but they are preferably designed and used in combination for synergism.

Preferred surfactants are the lauryl sulfates/sulfonates, coco sulfates/sulfonates, dodecylbenzene sulfates/sulfonates, lauryl and coco amine oxides, lauryl and coco betaines, lauryl and coco imidazolines, lauryl and coco gylcinates, lauryl and coco propinates and lauryl and coco amides, used independently or in combination.

For example, lauryl sulfate or dodecylbenzene sulfonate may be used as the primary surfactant and used in combination with smaller or equal amounts of one or more of the secondary surfactants, namely lauryl and coco amine oxides, lauryl and coco betaines, lauryl and coco sulfobetaines, lauryl and coco succinates, lauryl and coco sulfosuccinates, lauryl and coco imidazolines, lauryl and coco gylcinates, lauryl and coco propinates, lauryl and coco amides, lauryl and coco sarcosinates, lauryl and coco taurinates, lauryl and coco carboxylates, ethoxylated alcohols, ethoxylated amines, ethoxylated amides, and/or ethoxylated phenols.

Further, secondary surfactants such as lauryl and coco amine oxides, lauryl and coco betaines, lauryl and coco sulfobetaines, lauryl and coco succinates, lauryl and coco sulfosuccinates, lauryl and coco imidazolines, lauryl and coco gylcinates, lauryl and coco propinates, lauryl and coco amides, lauryl and coco sarcosinates, lauryl and coco taurinates, lauryl and coco carboxylates, ethoxylated alcohols, ethoxylated amines, ethoxylated amides, and/or ethoxylated phenols may be used as the primary surfactant in a myriad of simple to complex combinations. However, it is preferred to use from approximately one percent by weight to approximately five percent by weight of a primary surfactant, for example, lauryl sulfate or dodecylbenzene sulfonate, with approximately 0.1 percent by weight to approximately three percent by weight of a lauryl or coco amine oxide, or approximately 0.1 percent by weight to approximately three percent by weight of a lauryl or coco betaine, or approximately 0.1 percent by weight to approximately three percent by weight of a lauryl or coco imidazolines, or approximately 0.1 percent by weight to approximately three percent by weight of a lauryl or coco amide.

Non-detergent high foaming materials that may also be used as surfactants are those derived from sugars, proteins, carbohydrates, saponins and other alkaloids. The single surfactant and combinations of surfactants used in the bubble solution according to the present invention are all well known by those skilled in the art of making bubble solution and the total percentage of surfactant in the bubble solution according to the present invention preferably does not exceed approximately ten percent by weight, and is more preferably between approximately two percent by weight and approximately ten percent by weight of the bubble solution of the present invention.

### The Solvent.

Fast drying (or evaporating) solvents or solvent blends are commonly used in paints and adhesives to initiate a drying, curing or fixation of the base product. A fast drying solvent may be defined as a liquid having an evaporation rate significantly greater than the evaporation rate of water at room temperature. The aqueous bubble solution of the present invention includes a fast drying solvent or solvent blend used to dehydrate and preserve bubble(s) created from the bubble solution.

Examples of suitable solvents for use in the bubble solution are ethanol, methanol, propanol and isopropanol. The solvent or solvent blend dehydrates the thin bubble wall and sheds nearly all water out of the bubble shell. Complete dehydration of the bubble wall and evaporation of the solvent takes only a few seconds of exposure to the air, usually while the bubbles are floating. The resultant dry fully inflated translucent bubbles have exceptional strength and flexibility. The dehydrated bubbles are sufficiently durable that they may collide with dry solid objects and/or come to rest on a surface without breaking. The bubbles generally persist and have been observed to remain fully preserved for hours and even days.

The candidate fast drying solvents and solvent blends were narrowed through experimentation using candidate solvents. Some solvents, for example ethers, aldehydes, glycol ethers and ketones, are very harsh ingredients and therefor undesirable to incorporate into a consumer oriented product. Further, other than a few of the glycol ethers, these candidates did not function well for the present invention. As a result, the focus was shifted to common alcohols as the possible solvent and/or solvent blend of choice. For the above reasons, alcohols, namely methanol, ethanol, propanol and isopropanol, are preferred solvents for the bubble solution of the present invention. Ethanol and isopropanol are more preferred solvents (partly because of the toxicity of methanol), and ethanol is a most preferred solvent. Ethanol is incorporated into many consumer products such as mouthwash. Ethanol is also available as a specially denatured alcohol, abbreviated SDA or SD Alcohol. The reason for using denatured ethanol in consumer products is to make ingestion less palatable, thus preventing or reducing deliberate ingestion. The moderately toxic isopropanol is an alternative solvent over the remaining solvent choices. An example of a solvent blend which is compatible with the bubble solution is a combination of one or more of the glycol ethers with one or more of the common alcohols to improve or control evaporation if one should so desire. The bubble solution preferably includes between approximately two percent by weight and approximately 15 percent by weight of solvent. Further, due to flammability issues, the bubble solution preferable does not include more than ten percent alcohol.

The following example solutions were evaluated by dipping a traditional bubble wand into a sample solution and then one would blow through that wand with a breath of air. In each example, the amounts of each ingredient are approximate amounts by weight. Additionally, the bubble solution preferably includes at least approximately 40 percent water by weight, and more preferably includes at least approximately 90 percent water by weight.

Bubble survival rate is an observation of the percent by weight of bubbles blown that collide or come to rest on a surface without breaking. However, bubbles should be blown into an area to avoid collision with a solid surface or object for at least 3-5 seconds to allow the bubble wall to cure.

Bubble half-life is the time it takes for 50 percent of the resultant bubbles to expire at room temperature. At least ten individual trials should be performed on each solution for proper evaluation.

### EXAMPLE 1

| | |
|---|---|
| *Celvol 523S Polyvinyl Alcohol | 5.0 g |
| Lauryl Sulfate 60% | 4.5 g |
| Ethanol | 5.0 g |
| Water | 85.5 g |

Example 1 is a low solids starting formulation. Bubbles blown from this solution have a survival rate of at least 50% when coming in contact with a surface. The surviving bubbles have a half-life of about 18 to 25 minutes at room temperature.

### EXAMPLE 2

| | |
|---|---|
| *Celvol 523S Polyvinyl Alcohol | 8.0 g |
| Lauryl Sulfate 60% | 4.5 g |
| Ethanol | 5.0 g |
| Water | 85.5 g |

Example 2 contains 8% polymer for a stronger bubble wall and a survival rate of at least 90%. Bubble half-life is well over 4 hours at room temperature.

### EXAMPLE 3

| | |
|---|---|
| *Celvol 523S Polyvinyl Alcohol | 10.0 g |
| Lauryl Sulfate 60% | 5.0 g |
| Ethanol | 8.0 g |
| Water | 77.0 g |

In Example 3, 10% polymer adds tremendous bubble strength and the increase in ethanol accelerates the rate of dehydration. Bubble survival rate is nearly 95% and bubble half-life may be 16 hours at room temperature.

### EXAMPLE 4

| | |
|---|---|
| *Celvol 523S Polyvinyl Alcohol | 6.0 g |
| Lauryl Sulfate 60% | 4.0 g |
| Lauryl Amine Oxide 30% | 2.0 g |
| Ethanol | 6.0 g |
| Water | 82.0 g |

In Example 4, the surfactant combination of lauryl sulfate and lauryl amine oxide will give greater bubble production than in Examples 1-3. Bubble survival rate is over 80% and bubble half-life is 4-5 hours.

### EXAMPLE 5

| | |
|---|---|
| *Celvol 523S Polyvinyl Alcohol | 6.0 g |
| Lauryl Sulfate 60% | 4.0 g |
| Lauryl Amine Oxide 30% | 2.0 g |
| Lauryl Amide 100% | 0.5 g |
| Ethanol | 6.0 g |
| Water | 81.5 g |

Example 5, a small amount of lauryl amide is added to the formulation of Example 4 to give slightly better bubble production, higher survival rate and longer half life than in Example 4.

### EXAMPLE 6

| | |
|---|---|
| *Celvol 540S Polyvinyl Alcohol | 8.0 g |
| Dodecylbenzene Sulfate 60% | 2.0 g |
| Cocoamide DEA 100% | 2.0 g |
| Coco Amine Oxide 30% | 3.0 g |
| Ethanol | 7.0 g |
| Water | 78.0 g |

In Example 6, a different set of surfactants are used with 8% polymer. The surfactant cocoamide DEA is a liquid at room temperature so the resultant bubbles are not considered fully dry. These bubbles do have a survival rate near 95% and a half-life close to 10 hours, even though the bubble shell would retain some liquid in the form of cocoamide DEA.

### EXAMPLE 7

| | |
|---|---|
| *Celvol 540S Polyvinyl Alcohol | 8.0 g |
| Dodecylbenzene Sulfate 60% | 2.0 g |
| Cocoamide DEA 100% | 1.0 g |
| Coco Amine Oxide 30% | 2.0 g |
| Glycerin | 5.0 g |
| Ethanol | 8.0 g |
| Water | 74.0 g |

Glycerin is inserted into Example 7 to see what the effect might be. Bubble survival is still close to 95% and the half-life is around 8 hours. The use of slow evaporating liquids such as glycerin or cocoamide is not detrimental to these formulations and not even necessary to insert.

### EXAMPLE 8

| | |
|---|---|
| *Celvol 540S Polyvinyl Alcohol | 12.0 g |
| Lauryl Sulfate 60% | 3.0 g |
| Lauryl Amine Oxide 30% | 3.0 g |
| Lauryl Amide 100% | 1.0 g |
| Ethanol | 10.0 g |
| Water | 71.0 g |

Example 8 increases the polymer to 12% and alcohol to 10% gives us a near perfect bubble survival rate of 99% with most trials, and half-lives of 24 hours or more at room temperature.

### EXAMPLE 9

| | |
|---|---|
| *Celvol 203S Polyvinyl Alcohol | 20.0 g |
| Lauryl Sulfate 60% | 3.0 g |
| Lauryl Amine Oxide 30% | 3.0 g |
| Lauryl Amide 100% | 1.0 g |
| Ethanol | 10.0 g |
| Water | 63.0 g |

In Example 9, nearly twice the amount of low molecular weight polyvinyl alcohol must be used to attain the equivalent bubble performance of that in Example 8.

The above Examples are basic starting point formulations and can be modified and/or improved as necessary to include any or all of the following augmentations as known by those skilled in the art of making chemical products and specifically bubble solutions.

(1) One can adjust the pH of the solution with an acid or base. The pH can range from 4 to 10 with a nominal pH of 6.0 to 8.0 being preferred.
(2) A biocide, preservative or stabilizer may be added to extend the product shelf life and prevent spoilage.
(3) Humectants such as glycerin may be added.
(4) Inorganic salts, such as sodium chloride may be added as these compounds can influence solution viscosity.
(5) Fragrances and/or colorants may be used to enhance the visual and/or sensual appeal of the finished product.

There are many polymers, surfactants and solvents to choose from and many yet not discovered which may be substituted in the examples cited herein. It is impossible to include every conceivable polymer, surfactant, solvent or other material enhancement into this invention. However, anyone that uses the related polymers with a compatible fast drying solvent in a bubble producing surfactant solution should be successful. For example, some surfactant options/substitutions may include using a pre-formulated or off-the-shelf product such as a commercial bubble solution, dishwashing soap, shampoo, hand soap, detergent, cosmetic or other preparation capable of producing an aqueous bubble foam or film. Some solvent options/substitutions may be in the form of a non-aqueous or semi-aqueous cleaning/degreasing compound, paint thinner, paint remover, polish remover, heat transfer fluid, wax remover, parts/equipment cleaner, stripper, demulsifier or other plant, animal or petroleum extract/distillate capable of a casting a polymer film to a dry or semi-dry state. A suitable polymer option/substitute may be found in the form of an adhesive, sealant, glue, mold release agent, hairspray, hair gel, lotion, cosmetic, paint, coating, binder, fixative, thickener, plasticizer, viscosifier or other dry or semi-dry thin film forming agent.

While the invention herein disclosed has been described by means of specific embodiments and applications thereof, numerous modifications and variations could be made thereto by those skilled in the art without departing from the scope of the invention set forth in the claims.

I claim:

1. An aqueous bubble solution comprising:
a water soluble polymer;
at least one surfactant;
a drying agent selected from the set consisting of a fast drying solvent and a fast drying solvent blend; and
at least approximately 40 percent water.

2. The bubble solution of claim 1, wherein the water soluble polymer is approximately 0.5 percent by weight to approximately 30 percent by weight of the bubble solution.

3. The bubble solution of claim 2, wherein the water soluble polymer is selected from the group consisting of acrylic, acrylamide, block copolymer of propylene oxide, block copolymer of ethylene oxide, polyvinyl acetate, and polyvinyl alcohol.

4. The bubble solution of claim 3, wherein the water soluble polymer is polyvinyl alcohol.

5. The bubble solution of claim 4, wherein the water soluble polymer is a high molecular weight partial hydrolyzed polyvinyl alcohol.

6. The bubble solution of claim 5, wherein the water soluble polymer is a high molecular weight partially hydrolyzed polyvinyl alcohol and is between approximately three percent by weight and approximately 15 percent by weight of the bubble solution.

7. The bubble solution of claim 1, wherein the surfactant is approximately 0.5 percent by weight to approximately 30 percent by weight of the bubble solution.

8. The bubble solution of claim 7, wherein the surfactant is a high foaming surfactant.

9. The bubble solution of claim 7, wherein the surfactant is selected from a group, used independently or in combination, consisting of:
lauryl sulfates/sulfonates;
coco sulfates/sulfonates;
dodecylbenzene sulfates/sulfonates;
lauryl and coco amine oxides;
lauryl and coco betaines;
lauryl and coco imidazolines;
lauryl and coco gylcinates;
and lauryl and coco propinates and lauryl and coco amides.

10. The bubble solution of claim 9, wherein the surfactant is approximately 2 percent by weight to approximately 10 percent by weight of the bubble solution.

11. The bubble solution of claim 1, wherein the drying agent is approximately 0.25 percent by weight to approximately 30 percent by weight of the bubble solution.

12. The bubble solution of claim 11, wherein the drying agent is an alcohol.

13. The bubble solution of claim 12, wherein the drying agent is approximately two percent by weight to approximately ten percent by weight of the alcohol.

14. The bubble solution of claim 12, wherein the drying agent is selected from the group consisting of methanol, ethanol, propanol and isopropanol.

15. The bubble solution of claim 14, wherein the drying agent is selected from the group consisting of ethanol and isopropanol.

16. The bubble solution of claim 15, wherein the drying agent is ethanol.

17. The bubble solution of claim 16, wherein the drying agent is denatured ethanol.

18. The bubble solution of claim 1, wherein the drying agent is approximately two percent by weight to approximately 15 percent by weight of the bubble solution.

19. An aqueous bubble solution comprising:
approximately 0.5 percent by weight to approximately 30 percent by weight of a water soluble polymer;
approximately 0.5 percent by weight to approximately 30 percent by weight of a surfactant;
approximately 0.25 percent by weight to approximately 30 percent by weight of a fast drying solvent; and
approximately 40 percent by weight to approximately 98.75 percent by weight water.

20. An aqueous bubble solution comprising:
approximately three percent by weight to approximately 15 percent by weight of a polyvinyl alcohol;
approximately two percent by weight to approximately ten percent by weight surfactant;
approximately two percent by weight to approximately ten percent by weight ethanol; and
approximately 65 percent by weight to approximately 93 percent by weight water.
